(19) United States
(12) Patent Application Publication
(10) Pub. No.: US 2017/0155996 A1
(43) Pub. Date: Jun. 1, 2017

(54) EARPHONE DEVICE

(71) Applicant: Seungho LEE, Seoul (KR)

(72) Inventor: Seungho LEE, Seoul (KR)

(21) Appl. No.: 15/314,881

(22) PCT Filed: Jul. 7, 2015
(86) PCT No.: PCT/KR2015/006979

§ 371 Date: Nov. 29, 2016

(30) Foreign Application Priority Data
Jul. 8, 2014 (KR) 10-2014-0085112

(51) Int. Cl. H04R 1/10

(52) U.S. Cl. CPC H04R 1/1033; H04R 1/1066; H04R 1/1016

(57) ABSTRACT

An earphone device includes earphone cables that do not become twisted or entangled with each other. The volume of the earphone is reduced to facilitate storage and portability. The earphone device includes an earphone jack and a pair of earphone speakers for outputting sound. Earphone cables extended at a predetermined length from the earphone jack, and branch into first and second earphone cables to be connected respectively to the pair of earphone speakers. The first and second earphone cables have a coupling protrusion and a coupling groove at mutually facing surfaces such that the earphone cables can be separably coupled by male-female coupling of the coupling protrusion and the coupling groove. The coupling protrusion and the coupling groove are formed such that the earphone cables can be wound into a spiral shape and integrally united using the male-female coupling when the earphone cables are wound in a lengthwise direction.

### TECHNICAL FIELD

The present invention relates to an earphone device, and more particularly to an earphone device for preventing earphone cables, which are connected to earphones, from becoming twisted or entangled with each other and reducing the volume of the earphones to facilitate storage and carrying.

### BACKGROUND ART

Generally, earphones are devices connected to a terminal formed on one side of an acoustic device, such as an MP3 player, a mobile phone, and a PDA, to convert an electrical signal generated by the acoustic device into sound and output the same. By using such earphones, sound provided by sound devices can be more realistically heard without bothering other people in public places.

A pair of earphones is connected to an acoustic device by inserting an earphone jack into a terminal of the acoustic device. An earphone cable extends a predetermined length from the earphone jack and is branched into two parts at the predetermined length. Earphone speakers for outputting sound are respectively installed at ends of the branched earphone cables.

In the case of conventional earphones, earphone cables are wound or rolled when the earphones are carried or stored, whereby the earphone cables are twisted or entangled with each other. In particular, in the case of earphone cables bifurcately branched to be respectively connected to a pair of earphone speakers, the twisting or tangling phenomenon is more serious. When such twisting and tangling phenomena are repeated, electric wires embedded in the earphone cables may be short-circuited. In addition, when earphone cables are twisted or tangled, considerable time and effort are wasted in untangling the earphone cables for use thereof, thereby causing inconvenience in use.

Further, since earphone cables should be bound with a binding wire so as to store the earphone cables in a wound or rolled state, a separate binding member is required. However, although such a coupling member is used, a gap between earphone cables occurs, whereby it is difficult to neatly arrange the earphone cables, and storability and portability are decreased due to large volume of the earphones.

### RELATED ART DOCUMENT

(Patent Document 1) Korean Patent No. 10-0807703 (published on Feb. 28, 2008)

### DISCLOSURE

### Technical Problem

The present invention has been made in view of the above problems, and it is an object of the present invention to provide an earphone device for preventing earphone cables from becoming twisted or entangled with each other and being disconnected by integratively coupling earphone cables branched when carrying or during storage.

It is another object of the present invention to provide an earphone device for reducing the volume of an earphone and facilitating storage and carrying by winding earphone cables into a spiral shape to be integratively coupled with each other without using a separate coupling member.

### Technical Solution

In accordance with an aspect of the present invention, the above and other objects can be accomplished by the provision of an earphone device, including an earphone jack connected to an acoustic device; a pair of earphone speakers for outputting sound; and an earphone cable extending a predetermined length from the earphone jack and branched to first and second earphone cables at a predetermined part, wherein the branched first and second earphone cables are respectively connected to a pair of earphone speakers, coupling protrusions and grooves are formed at mutually facing surfaces of the first and second earphone cables, and the first earphone cable is separably coupled with the second earphone cable by female-male coupling between the coupling protrusions and the coupling grooves.

The coupling protrusions and the coupling grooves may be formed at both sides of the earphone cable, and thus, the earphone cable may be wound into a spiral shape by female-male coupling between the coupling protrusions and the coupling grooves when the earphone cable is wound in a longitudinal direction, thereby being integrally coupled.

The coupling protrusions and the coupling grooves may be vertically in parallel with a longitudinal direction of the earphone cable.

The earphone cable may have an one-sided uneven cross-sectional shape wherein coupling protrusions are formed at one side of the first earphone cable, and coupling grooves are formed such that the coupling protrusions are inserted into one side of the second earphone cable facing the side of the first earphone cable.

The earphone cable may have an one-sided uneven cross-sectional shape wherein coupling protrusions and grooves are formed at one side of the first earphone cable, and coupling grooves and protrusions are formed at one side of the second earphone cable facing the side of the first earphone cable such that the coupling protrusions and grooves are respectively, correspondingly inserted into the coupling protrusions and grooves of the first earphone cable.

The earphone cable may have a double-sided uneven cross-sectional shape wherein coupling protrusions are formed at one side of the earphone cable of the earphone cable and coupling grooves are formed at another side of the earphone cable, wherein, when the earphone cable is wound into a spiral shape in a longitudinal direction, the coupling protrusions formed at one side of the earphone cable are inserted into and coupled with the coupling grooves formed at another side of the earphone cable.

The earphone cable may has a double-sided uneven cross-sectional shape wherein coupling protrusions and grooves are formed at one side of the earphone cable and the coupling grooves and protrusions are formed at another side of the earphone cable, wherein, when the earphone cable is wound into a spiral shape in a longitudinal direction, the coupling protrusions formed at one side of the earphone cable are inserted into and coupled with the coupling grooves formed at another side of the earphone cable and the coupling protrusions formed at the another side of the earphone cable are inserted into and coupled with the coupling grooves formed the side of the earphone cable.

The coupling protrusions and the coupling grooves may be formed in a horizontal shape perpendicular to a longitudinal direction of the earphone cable.

The coupling protrusions and the coupling grooves may be alternately, repeatedly formed along a longitudinal direction of the earphone cable.

The earphone cable may have an one-sided uneven cross-sectional shape wherein coupling protrusions and grooves are alternately, repeatedly formed at one side of the first earphone cable along a longitudinal direction of the first earphone cable, and coupling grooves and coupling protrusions are alternately, repeatedly formed along a longitudinal direction of the second earphone cable at one side of the second earphone cable facing the side at the first earphone cable such that the coupling protrusions of grooves of the first earphone cable are respectively, correspondingly inserted into the coupling protrusions of grooves of the second earphone cable.

The earphone cable may have a double-sided uneven cross-sectional shape wherein coupling protrusions and grooves are alternately, repeatedly formed at the earphone cable along a longitudinal direction of the earphone cable, wherein, when the earphone cable is wound into a spiral shape in a longitudinal direction, the coupling protrusions and grooves formed at one side of the earphone cable are respectively, correspondingly inserted into and coupled with the coupling grooves and protrusions formed at another side of the earphone cable.

The earphone device may further include a detachable/attachable operation part that moves between the first and second earphone cables, is installed to move along the earphone cable, and enables the coupling protrusions and the coupling grooves to be separated from each other or coupled with each other by moving along the earphone cable.

In accordance with another aspect of the present invention, there is provided an earphone device, including an earphone jack connected to an acoustic device; earphone speakers for outputting sound; a necklace-type cable extending a predetermined length from the earphone jack and having a circular necklace shape to be hanged around user's neck; and an earphone cable branched from the necklace-type cable and connected to the earphone speakers, wherein coupling protrusions and grooves are formed at mutually facing surfaces of the necklace-type cable and the earphone cable, and thus, the necklace-type cable and the earphone cable are separably coupled with each other by female-male coupling between the coupling protrusions and the coupling grooves.

The coupling protrusions and the coupling grooves may be vertically in parallel with a longitudinal direction of the necklace-type cable and the earphone cable.

The coupling protrusions and the coupling grooves may be formed in a horizontal shape perpendicular to a longitudinal direction of the necklace-type cable and the earphone cable.

The earphone device may further include a detachable/attachable operation part that moves between the necklace-type cable and the earphone cable, is installed to move along the necklace-type cable and the earphone cable, and enables the coupling protrusions and the coupling grooves to be separated from each other or coupled with each other by moving along the necklace-type cable and the earphone cable.

### Advantageous Effects

An earphone device of the present invention is constituted to integrate branched earphone cables into one earphone cable by female-male coupling between coupling protrusions and coupling grooves respectively formed at mutually facing surfaces of the branched earphone cables. Accordingly, when earphones are stored or carried, the earphone cables may be prevented from becoming twisted or entangled with each other and being disconnected.

In addition, according to the present invention, the coupling protrusions and the coupling grooves may be coupled with each other or separated from each other due to a detachable/attachable operation part moving along an earphone cable and a branched length of the earphone cable may be controlled according to a moving position of the detachable/attachable operation part, thereby providing convenience of use.

Further, according to the present invention, the earphone cables are constituted to be integratively coupled to each other by female-male coupling between coupling protrusions and coupling grooves formed at both sides of the earphone cables when wound into a spiral shape. Accordingly, the volume of the earphones cables may be reduced and the earphone cables may be neatly arranged, without using a separate coupling member, thereby improving storability and portability.

### DESCRIPTION OF DRAWINGS

FIG. 1 illustrates a front view of an earphone device according to a first preferred example of the present invention.

FIG. 2a illustrates a sectional view of an embodiment of A and B parts of FIG. 1. Particularly, a cross-sectional view of separated A and B parts is illustrated.

FIG. 2b a sectional view of an embodiment of A and B parts of FIG. 1. Particularly, a cross-sectional view of coupled A and B parts is illustrated.

FIG. 3a illustrates a sectional view of another embodiment of A and B parts of FIG. 1. Particularly, a cross-sectional view of separated A and B parts is illustrated.

FIG. 3b illustrates a sectional view of another embodiment of A and B parts of FIG. 1. Particularly, a cross-sectional view of coupled A and B parts is illustrated.

FIG. 4a illustrates a perspective view of a detachable/attachable operation part illustrated in FIG. 1.

FIG. 4b is a sectional view showing an operation state of a detachable/attachable operation part illustrated in FIG. 1.

FIG. 5 illustrates a front view of an earphone device according to a second preferred example of the present invention.

FIG. 6a illustrates a sectional view of an embodiment of A and B parts of FIG. 5. Particularly, a longitudinal sectional view of separated A and B parts is illustrated.

FIG. 6b illustrates a sectional view of an embodiment of A and B parts of FIG. 5. Particularly, a longitudinal sectional view of coupled A and B parts is illustrated.

FIG. 7a illustrates a perspective view of a detachable/attachable operation part illustrated in FIG. 5.

FIG. 7b is a sectional view showing an operation state of a detachable/attachable operation part illustrated in FIG. 5.

FIG. 8 illustrates a front view of an earphone device according to a third preferred example of the present invention.

FIG. 9a illustrates a sectional view of an embodiment of A, B, and C parts of FIG. 8. Particularly, a cross-sectional view of separated A and B parts is illustrated.

FIG. 9b illustrates a sectional view of an embodiment of A, B, and C parts of FIG. 8. Particularly, a cross-sectional view of coupled A and B parts is illustrated.

FIG. 9c illustrates a sectional view of an embodiment of A, B, and C parts of FIG. 8. Particularly, a cross-sectional view of a C part is illustrated.

FIG. 10a illustrates a sectional view of another embodiment of A, B, and C parts of FIG. 8. Particularly, a cross-sectional view of separated A and B parts is illustrated.

FIG. 10b illustrates a sectional view of another embodiment of A, B, and C parts of FIG. 8. Particularly, a cross-sectional view of coupled A and B parts is illustrated.

FIG. 10c illustrates a sectional view of another embodiment of A, B, and C parts of FIG. 8. Particularly, a cross-sectional view of a C part is illustrated.

FIG. 11a illustrates a state of earphone cables wound into a spiral shape and integratively coupled with each other, upon storage of an earphone device according to a third preferred example of the present invention.

FIG. 11b illustrates a sectional view taken along line D-D′ of FIG. 11a.

FIG. 11c illustrates a side view of an earphone device wherein earphone cables are wound into a spiral shape and integratively coupled with each other.

FIG. 12 illustrates a front view of an earphone device according to a fourth preferred example of the present invention.

FIG. 13a illustrates a sectional view of an embodiment of A, B, and C parts of FIG. 12. Particularly, a longitudinal sectional view of separated A and B parts is illustrated.

FIG. 13b illustrates a sectional view of an embodiment of A, B, and C parts of FIG. 12. Particularly, a longitudinal sectional view of coupled A and B parts is illustrated.

FIG. 13c illustrates a sectional view of an embodiment of A, B, and C parts of FIG. 12. Particularly, a longitudinal sectional view of a C part is illustrated.

FIG. 14a illustrates a state of earphone cables wound into a spiral shape and integratively coupled with each other, upon storage of an earphone device according to a fourth preferred example of the present invention.

FIG. 14b illustrates a sectional view taken along E-E′ line of FIG. 14a.

FIG. 15 illustrates a perspective view of an earphone device according to a fifth preferred example of the present invention.

FIG. 16a is a perspective view showing an operation state of a detachable/attachable operation part illustrated in FIG. 15.

FIG. 16b illustrates a longitudinal sectional view of the detachable/attachable operation part of FIG. 16a.

FIG. 17 illustrates a perspective view of an earphone device according to a sixth preferred example of the present invention.

FIG. 18a is a perspective view showing an operation state of a detachable/attachable operation part illustrated in FIG. 17.

FIG. 18b illustrates a longitudinal sectional view of the detachable/attachable operation part of FIG. 18a.

### BEST MODE

The attached drawings for illustrating exemplary embodiments of the present invention are referred to in order to gain a sufficient understanding of the present invention, the merits thereof, and the objectives accomplished by the implementation of the present invention. The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. Meanwhile, the terminology used herein is for the purpose of describing particular embodiments and is not intended to limit the invention. Like reference numerals in the drawings denote like elements.

Hereinafter, earphone devices according to exemplary embodiments of the present invention will be described in detail with reference to the accompanying drawings. For reference, in the following description of the present invention, a detailed description of known functions and configurations incorporated herein will be omitted when it may make the subject matter of the present invention unclear.

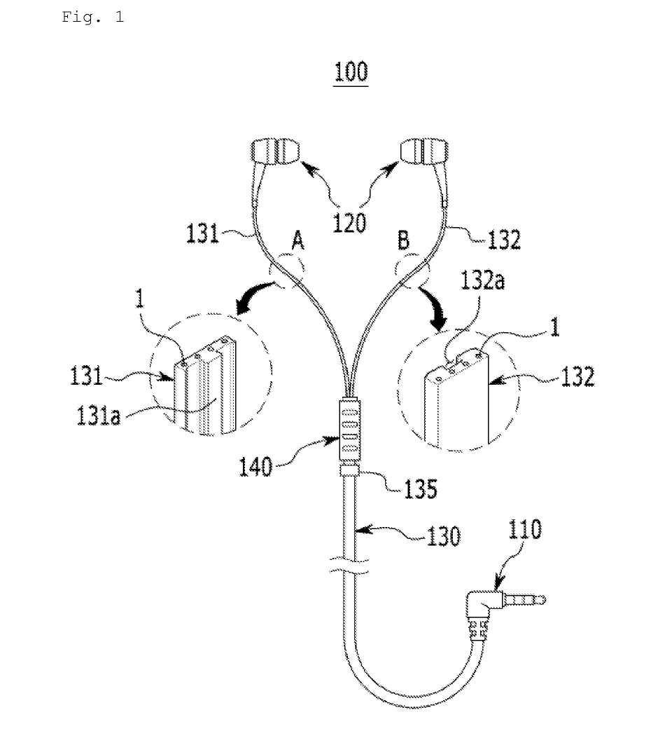

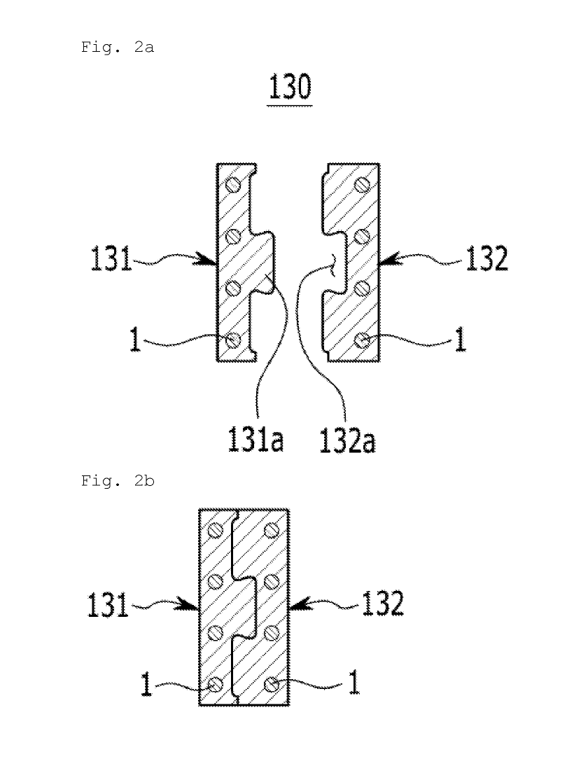

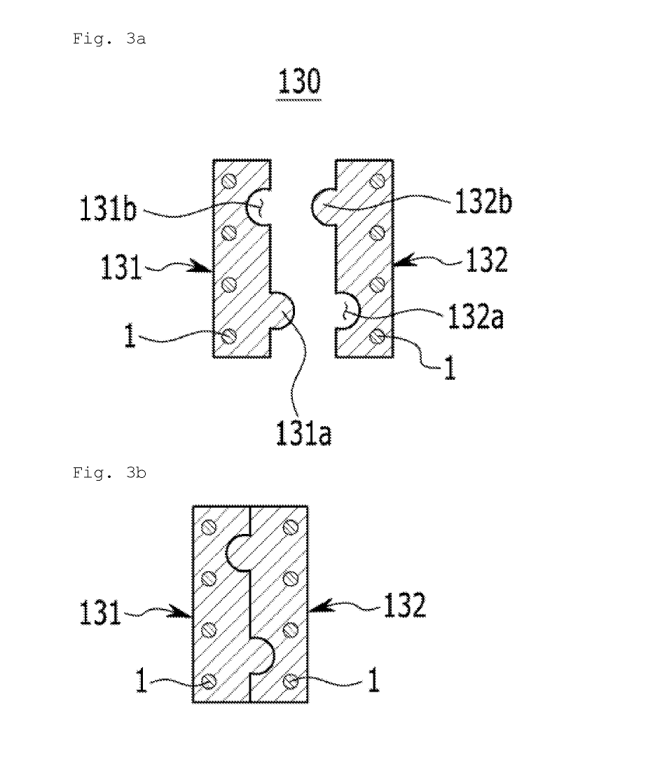

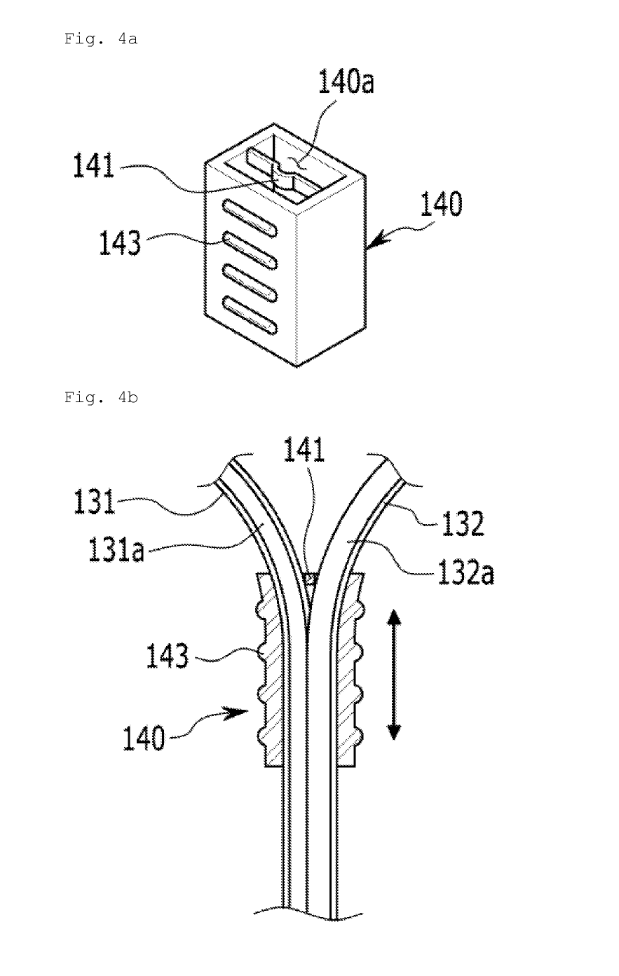

FIG. 1 illustrates a front view of an earphone device according to a first preferred example of the present invention. FIG. 2a illustrates a sectional view of an embodiment of A and B parts of FIG. 1. Particularly, a cross-sectional view of separated A and B parts is illustrated. FIG. 2b a sectional view of an embodiment of A and B parts of FIG. 1. Particularly, a cross-sectional view of coupled A and B parts is illustrated. FIG. 3a illustrates a sectional view of another embodiment of A and B parts of FIG. 1. Particularly, a cross-sectional view of separated A and B parts is illustrated. FIG. 3b illustrates a sectional view of another embodiment of A and B parts of FIG. 1. Particularly, a cross-sectional view of coupled A and B parts is illustrated. FIG. 4a illustrates a perspective view of a detachable/attachable operation part illustrated in FIG. 1. FIG. 4b is a sectional view showing an operation state of a detachable/attachable operation part illustrated in FIG. 1.

As illustrated in FIGS. 1 to 4, the earphone device 100 according to a first preferred example of the present invention may include an earphone jack 110, earphone speakers 120, an earphone cable 130, and a detachable/attachable operation part 140.

The earphone jack 110 is inserted into and electrically connected to a terminal formed at a side of an acoustic device (not shown) such as an MP3 player, a mobile phone, or a PDA. The earphone jack 110 corresponds to a publicly known technology, and thus, detailed description thereof is omitted.

The earphone speakers 120 convert an electrical signal, which is transferred from an acoustic device via the earphone cable 130 connected to the earphone jack 110, into sound and output the same. A pair of earphone speakers 120 are provided and respectively connected to ends of first and second earphone cables 131 and 132 described below. The earphone speakers 120 may have a shape designed to be inserted into and seated in a user's ears. Inside the earphone speakers 120, constructions for converting an electrical signal into sound, e.g., a diaphragm, a magnet, a voice coil, and the like, may be provided. The earphone speakers 120 correspond to a publicly known technology, and thus, detailed description of a construction thereof is omitted.

An end of the earphone cable 130 is connected to the earphone jack 110, and an electrical signal of an acoustic device is transmitted to the earphone speakers 120 connected to another end of the earphone cable 130. An electric wire for transmitting a sound signal is accommodated in the interior of the earphone cable 130. The earphone cable 130 is preferably made of a flexible material and is preferably formed in a thin and long plate shape. The earphone cable 130 extends a predetermined length from the earphone jack 110 and is branched into the first and second earphone cables 131 and 132 at a predetermined part in a “Y” shape. Accordingly, the first and second earphone cables 131 and 132 are respectively connected to a pair of the earphone speakers 120. At mutually facing surfaces of an entire or partial length of the first and second earphone cables 131 and 132, coupling protrusions 131a and coupling grooves 132a are formed, whereby the first earphone cable 131 is separably coupled with the second earphone cable 132 by female-male coupling between the coupling protrusions 131a and the coupling grooves 132a. The coupling protrusions 131a and the coupling grooves 132a may be vertically formed in parallel with the longitudinal direction of the earphone cable 130. For example, as illustrated in FIGS. 2a and 2b, one side of the earphone cable 130 may have an uneven cross-sectional shape wherein the coupling protrusions 131a are longitudinally, lengthily formed at one side surface of the first earphone cable 131 in parallel with the longitudinal direction of the first earphone cable 131, and the coupling grooves 132a are longitudinally, lengthily formed in parallel with the longitudinal direction of the second earphone cable 132 such that the coupling protrusions 131a are inserted into one side of the second earphone cable 132 facing one side of the first earphone cable 131. In this case, the earphone cable 130 has a cross-sectional structure wherein female and male parts are distinguished. Alternatively, as illustrated in FIGS. 3a and 3b, a surface of the earphone cable 130 may have a double uneven cross-sectional shape wherein coupling protrusions 131a and coupling grooves 131b are longitudinally, lengthily formed in parallel with the longitudinal direction of the first earphone cable 131 at one side of the first earphone cable 131 and, to be correspondingly inserted into each of the coupling protrusions 131a and the coupling grooves 131b, coupling protrusions 132a and coupling grooves 132b are formed at one side of the second earphone cable 132 facing one side of the first earphone cable 131. In this case, the earphone cable 130 has a symmetrical structure wherein female and male parts are not distinguished. By separably coupling the one-sided vertical coupling protrusions 131a (131a, 132b) and coupling grooves 132a (131b, 132a) of the earphone cable 130 with each other like this, the bifurcately branched first and second earphone cables 131 and 132 are integrated into one earphone cable, thereby preventing the earphone cable 130 from becoming twisted or entangled upon storage or carrying of an earphone. At the earphone cable 130, a stopper 135 for preventing the detachable/attachable operation part 140 from downwardly moving may be installed. The stopper 135 is preferably installed a part at which the first and second earphone cables 131 and 132 are branched. In addition, at any one of the branch first and second earphone cables 131 and 132 of the earphone cable 130, a microphone and a volume control button (not shown) may be provided.

The detachable/attachable operation part 140 includes an inner hole 140a through which the first and second earphone cables 131 and 132 pass, and is installed to move in the longitudinal direction of the earphone cable 130. Due to the detachable/attachable operation part 140 reciprocating along the earphone cable 130, the coupling protrusions 131a and the coupling grooves 132a may be mutually fitted or separated from each other. The detachable/attachable operation part 140 is moved toward the earphone speakers 120 (in an upper direction of FIG. 1) so as to engage the coupling protrusions 131a of the first earphone cable 131 with the coupling grooves 132a of the second earphone cable 132, whereby the coupling protrusions 131a of the first earphone cable 131 are integratively coupled with the coupling grooves 132a of the second earphone cable 132. Here, the first and second earphone cables 131 and 132 are gathered by an inner part of the detachable/attachable operation part 140, and thus, the coupling protrusions 131a are mutually coupled with the coupling grooves 132a. In addition, the detachable/attachable operation part 140 is moved toward the stopper 135 (in a lower direction of FIG. 1) so as to separate the coupling protrusions 131a of the first earphone cable 131 and the coupling grooves 132a of the second earphone cable 132 from each other, whereby the earphone cable 130 is bifurcately separated. Here, the first and second earphone cables 131 and 132 are opened by an operation protrusion 141 provided at the detachable/attachable operation part 140, and thus, the coupling protrusions 131a and the coupling grooves 132a are separated from each other. In addition, the detachable/attachable operation part 140 is installed to reciprocate along the earphone cable 130, and thus, a branched length of the earphone cable 130 may be controlled according to a moving position of the detachable/attachable operation part 140. The detachable/attachable operation part 140 is preferably made of a plastic material to reduce friction force upon reciprocating along the earphone cable 130. In addition, the detachable/attachable operation part 140 preferably has a plurality of non-slip protrusions 143 at an outer surface thereof so as to facilitate movement of the detachable/attachable operation part 140 by increasing friction force.

Hereinafter, an operation principle of the earphone device 100 according to the first preferred example of the present invention is described. By engaging the coupling protrusions and grooves 131a and 132a with each other, which are longitudinally, lengthily formed at facing surfaces of the first and second earphone cables 131 and 132 in parallel with the longitudinal direction of the earphone cable 130, by female-male coupling, the bifurcately branched first and second earphone cables 131 and 132 may be integrated into one earphone cable. Accordingly, the earphone cable 130 may be prevented from becoming twisted or entangled upon storage and carrying of an earphone. In addition, upon use of the earphones, the first earphone cable 131 and the second earphone cable 132 are separated from each other by releasing coupling between the coupling protrusions 131a and the coupling grooves 132a, and thus, the earphones may be used. In addition, the coupling protrusions 131a and the coupling grooves 132a are coupled with each other or separated from each other by movement of the detachable/attachable operation part 140. Particularly, the detachable/attachable operation part 140 is moved toward the earphone speakers 120 to couple the coupling protrusions 131a with the coupling grooves 132a, and the detachable/attachable operation part 140 is moved toward the stopper 135 to separate the coupling protrusions 131a separated from the coupling grooves 132a. Accordingly, the separation may be accomplished by small force. Therefore, by designing the branched parts of the earphone cable 130 to be integratively coupled to each other, the earphone cable 130 is prevented from being entangled or twisted and being disconnected upon storage or carrying of the earphone. In addition, convenience of use may be increased by designing a branched length of the earphone cable 130 to be controlled.

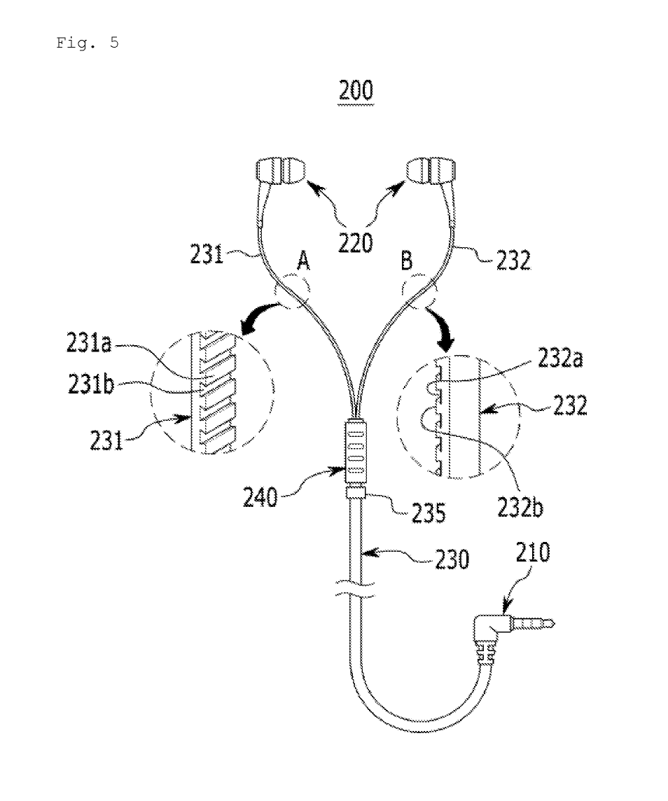

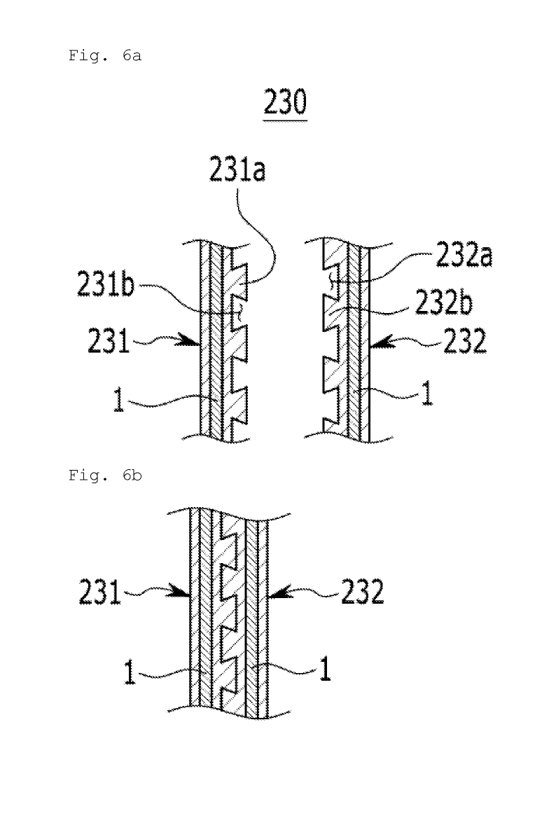

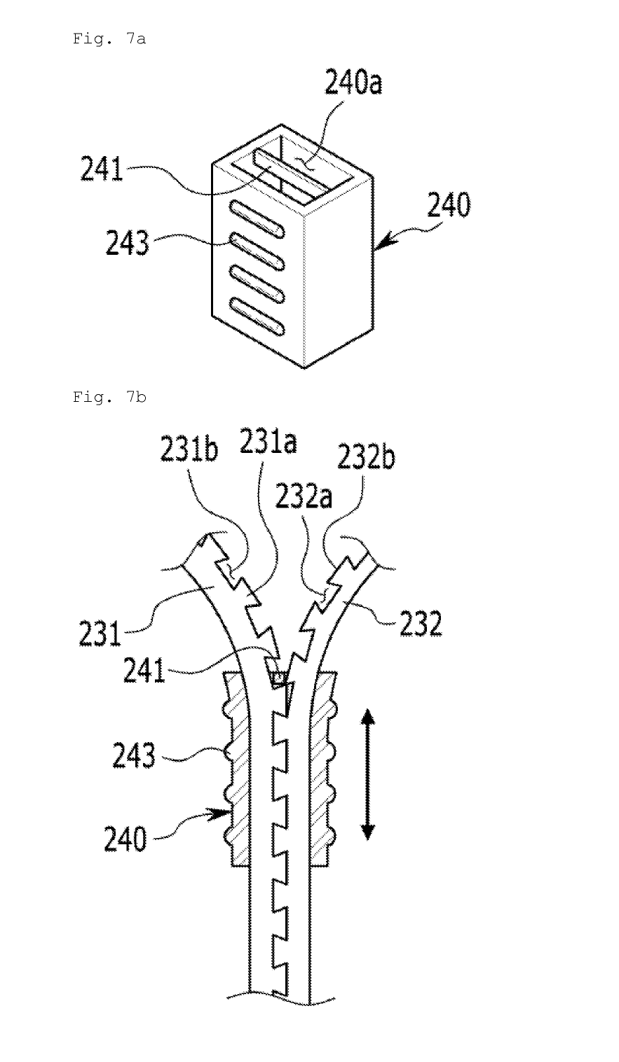

FIG. 5 illustrates a front view of an earphone device according to a second preferred example of the present invention. FIG. 6a illustrates a sectional view of an embodiment of A and B parts of FIG. 5. Particularly, a longitudinal sectional view of separated A and B parts is illustrated. FIG. 6b illustrates a sectional view of an embodiment of A and B parts of FIG. 5. Particularly, a longitudinal sectional view of coupled A and B parts is illustrated. FIG. 7a illustrates a perspective view of a detachable/attachable operation part illustrated in FIG. 5. FIG. 7b is a sectional view showing an operation state of a detachable/attachable operation part illustrated in FIG. 5.

As illustrated in FIGS. 5 to 7, the earphone device 200 according to the second preferred example of the present invention may include an earphone jack 210, earphone speakers 220, an earphone cable 230, and a detachable/attachable operation part 240. Descriptions of these components, except for the earphone cable 230, are the same as the particulars of the first example described referring to FIGS. 1 to 4. Accordingly, detailed descriptions of components performing the same functions as those of the first example, the earphone jack 210, the earphone speakers 220, and the detachable/attachable operation part 240 are omitted.

An end of the earphone cable 230 is connected to the earphone jack 210, and an electrical signal of an acoustic device is transmitted to the earphone speakers 220 connected to another end of the earphone cable 230. An electric wire for transmitting a sound signal is accommodated in the interior of the earphone cable 230. The earphone cable 230 is preferably made of a flexible material and is preferably formed in a thin and long plate shape. The earphone cable 230 extends a predetermined length from the earphone jack 210 and is branched into the first and second earphone cables 231 and 232 at a predetermined part in a “Y” shape. Accordingly, the first and second earphone cables 231 and 232 are respectively connected to a pair of the earphone speakers 220. At mutually facing surfaces of an entire or partial length of the first and second earphone cables 231 and 232, coupling protrusions 231a and 231b and coupling grooves 231b and 232a are formed, whereby the first earphone cable 231 is separably coupled with the second earphone cable 232 by female-male coupling between the coupling protrusions 231a and 232b and the coupling grooves 231b and 232a. The coupling protrusions 231a and 232b and the coupling grooves 231b and 232a may be formed in a horizontal shape perpendicular to the longitudinal direction of the earphone cable 230. The coupling protrusions 231a and 232b and the coupling grooves 231b and 232a may be alternately, repeatedly formed in the longitudinal direction of the earphone cable 230. For example, as illustrated in FIGS. 6a and 6b, a surface of the earphone cable 230 may have an uneven cross-sectional shape wherein the coupling protrusions 231a, which have a horizontal shape perpendicular to the longitudinal direction of the first earphone cable 231, and the coupling grooves 231b are alternately, repeatedly formed in the longitudinal direction of the first earphone cable 231 at one side of the first earphone cable 231, and the coupling grooves 232a, which have a horizontal shape perpendicular to the longitudinal direction of the second earphone cable 232, and the coupling protrusions 232b are alternately, repeatedly formed in the longitudinal direction of the second earphone cable 232 at one side of the second earphone cable 232 facing the side of the first earphone cable 231 so as to be correspondingly inserted into each of the coupling protrusions 231a and coupling grooves 231b of the first earphone cable 231. In particular, the coupling protrusions 231a and 232b are formed such that the cross-sectional areas thereof gradually increase toward the outside, and the coupling grooves 231b and 232a are formed such that the cross-sectional areas thereof gradually increase toward the inside, whereby a coupling state between the coupling protrusions 231a and 232b and the coupling grooves 231b and 232a may be further strengthened. By separably coupling the one-sided vertical coupling protrusions 231a and 232b and coupling grooves 231b and 232a of the earphone cable 230 with each other like this, the bifurcately branched first and second earphone cables 231 and 232 are integrated into one earphone cable, thereby preventing the earphone cable 230 from becoming twisted or entangled upon storage or carrying of an earphone. At the earphone cable 230, a stopper 235 for preventing the detachable/attachable operation part 240 from downwardly moving may be installed. The stopper 235 is preferably installed a part at which the first and second earphone cables 231 and 232 are branched. In addition, at any one of the branch first and second earphone cables 231 and 232 of the earphone cable 230, a microphone and a volume control button (not shown) may be provided.

Hereinafter, an operation principle of the earphone device 200 according to the second preferred example of the present invention is described. By engaging the coupling protrusions 231a and 232b, which are alternately, repeatedly formed in a horizontal shape perpendicular to the longitudinal direction of the earphone cable 230, with the coupling grooves 231b and 232a, which are alternately, repeatedly formed, at mutually facing surfaces of the first and second earphone cables 231 and 232 by female-male coupling, the bifurcately branched first and second earphone cables 231 and 232 may be integrated into one earphone cable. Accordingly, the earphone cable 230 may be prevented from becoming twisted or entangled upon storage and carrying of an earphone. In addition, upon use of the earphones, the first earphone cable 231 and the second earphone cable 232 are separated from each other by releasing coupling between the coupling protrusions 231a and 232b and the coupling grooves 231b and 232a, and thus, the earphones may be used. In addition, the coupling protrusions 231a and 232b and the coupling grooves 231b and 232a are coupled with each other or separated from each other by movement of the detachable/attachable operation part 240. Particularly, the detachable/attachable operation part 240 is moved toward the earphone speakers 220 to couple the coupling protrusions 231a and 232b with the coupling grooves 231b and 232a, and the detachable/attachable operation part 240 is moved toward the stopper 235 to separate the coupling protrusions 231a and 232b separated from the coupling grooves 231b and 232a. Accordingly, the separation may be accomplished by small force. Therefore, by designing the branched parts of the earphone cable 230 to be integratively coupled to each other, the earphone cable 230 is prevented from being entangled or twisted and being disconnected upon storage or carrying of the earphone. In addition, convenience of use may be increased by designing a branched length of the earphone cable 230 to be controlled.

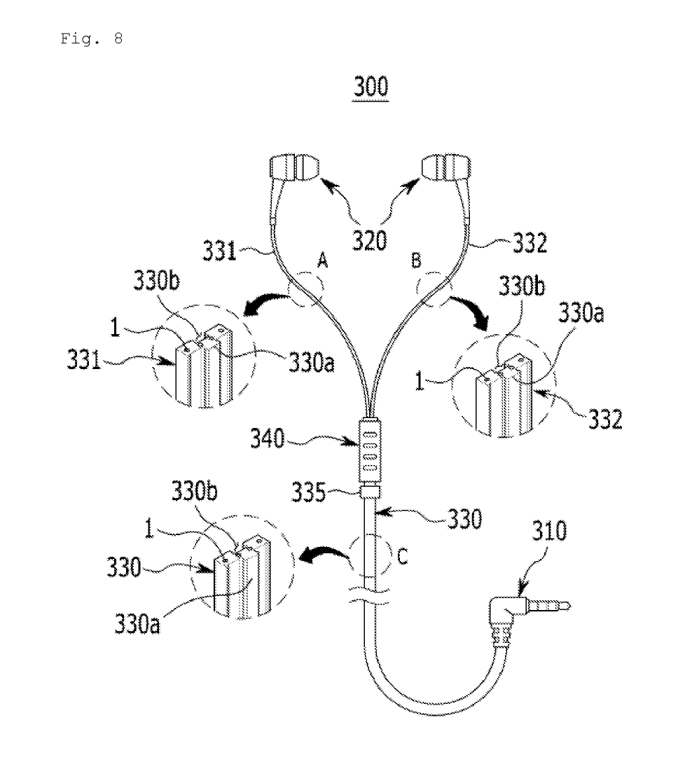

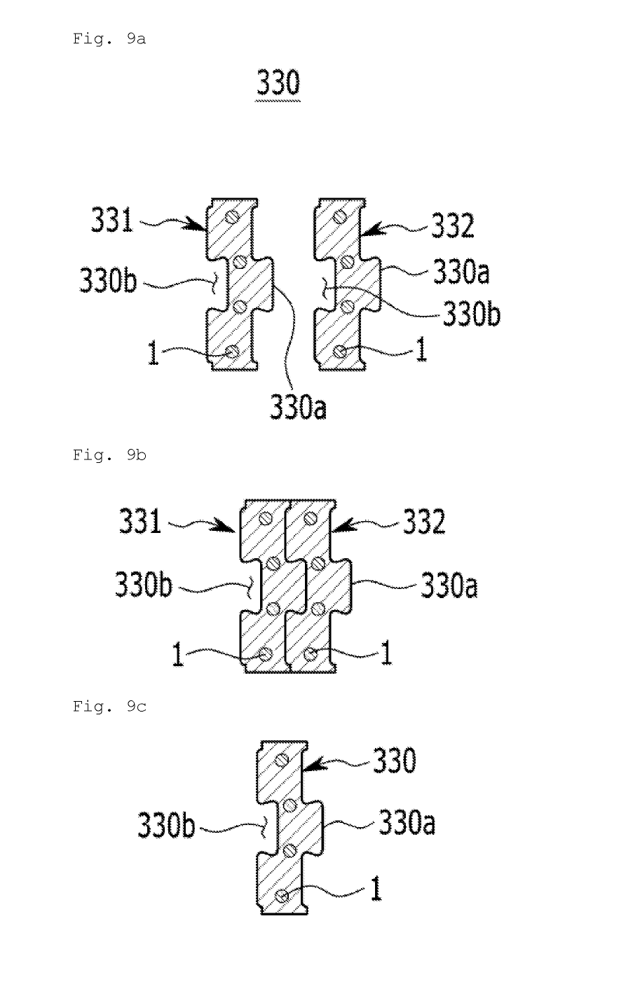

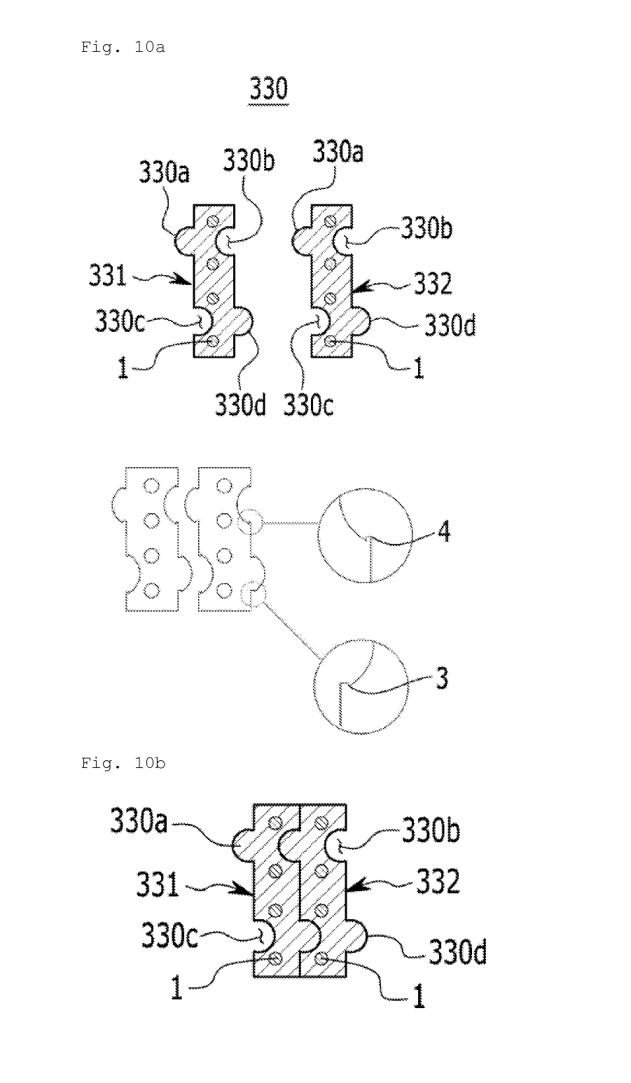

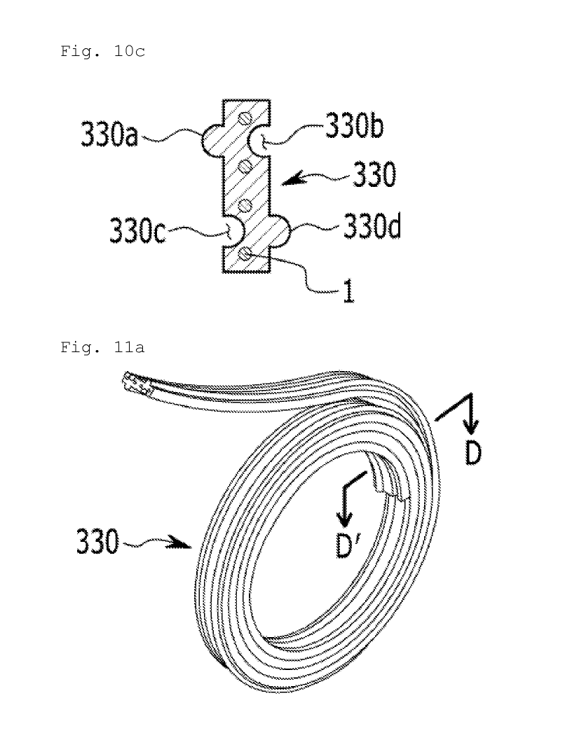

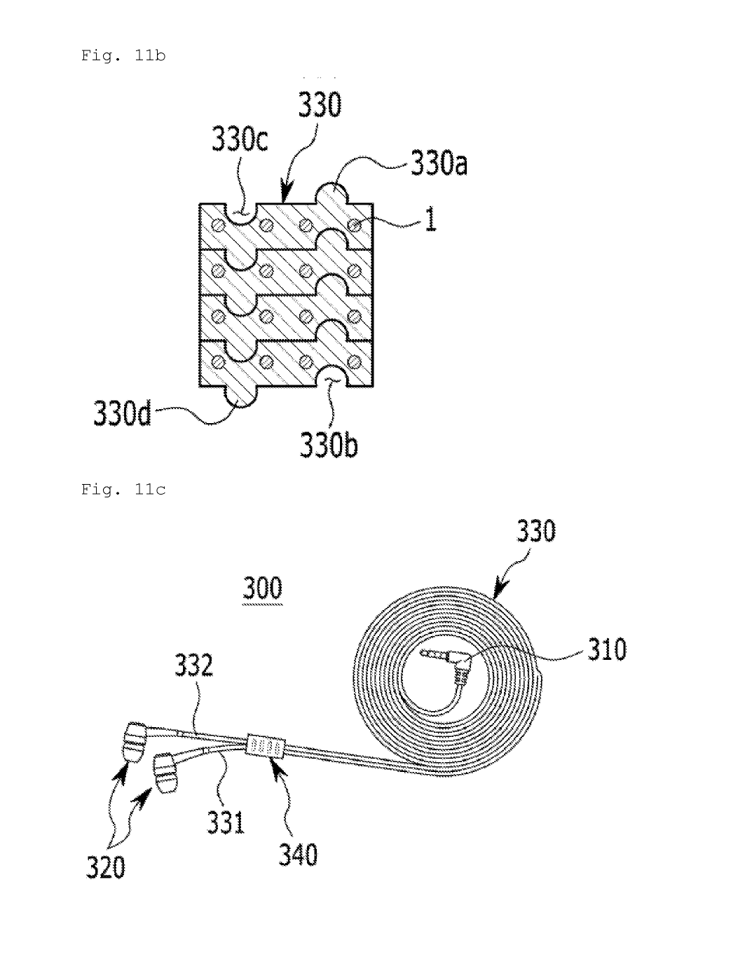

FIG. 8 illustrates a front view of an earphone device according to a third preferred example of the present invention. FIG. 9a illustrates a sectional view of an embodiment of A, B, and C parts of FIG. 8. Particularly, a cross-sectional view of separated A and B parts is illustrated. FIG. 9b illustrates a sectional view of an embodiment of A, B, and C parts of FIG. 8. Particularly, a cross-sectional view of coupled A and B parts is illustrated. FIG. 9c illustrates a sectional view of an embodiment of A, B, and C parts of FIG. 8. Particularly, a cross-sectional view of a C part is illustrated. FIG. 10a illustrates a sectional view of another embodiment of A, B, and C parts of FIG. 8. Particularly, a cross-sectional view of separated A and B parts is illustrated. FIG. 10b illustrates a sectional view of another embodiment of A, B, and C parts of FIG. 8. Particularly, a cross-sectional view of coupled A and B parts is illustrated. FIG. 10c illustrates a sectional view of another embodiment of A, B, and C parts of FIG. 8. Particularly, a cross-sectional view of a C part is illustrated. FIG. 11a illustrates a state of earphone cables wound into a spiral shape and integratively coupled with each other, upon storage of an earphone device according to a third preferred example of the present invention. FIG. 11b illustrates a sectional view taken along line D-D′ of FIG. 11a. FIG. 11c illustrates a side view of an earphone device wherein earphone cables are wound into a spiral shape and integratively coupled with each other.

As illustrated in FIGS. 8 to 11, the earphone device 300 according to the third preferred example of the present invention may include an earphone jack 310, earphone speakers 320, an earphone cable 330, and a detachable/attachable operation part 340. Descriptions of these components, except for the earphone cable 330, are the same as the particulars of the first example described referring to FIGS. 1 to 4. Accordingly, detailed descriptions of components performing the same functions as those of the first example, the earphone jack 310, the earphone speakers 320, and the detachable/attachable operation part 340 are omitted.

An end of the earphone cable 330 is connected to the earphone jack 310, and an electrical signal of an acoustic device is transmitted to the earphone speakers 320 connected to another end of the earphone cable 330. An electric wire for transmitting a sound signal is accommodated in the interior of the earphone cable 330. The earphone cable 330 is preferably made of a flexible material and is preferably formed in a thin and long plate shape. The earphone cable 330 extends a predetermined length from the earphone jack 310 and is branched into the first and second earphone cables 331 and 332 at a predetermined part in a “Y” shape. Accordingly, the first and second earphone cables 331 and 332 are respectively connected to a pair of the earphone speakers 320. At mutually facing surfaces of an entire or partial length of the first and second earphone cables 331 and 332, coupling protrusions 330a and coupling grooves 330b are formed, whereby the first earphone cable 331 is separably coupled with the second earphone cable 332 by female-male coupling between the coupling protrusions 330a and the coupling grooves 330b. In addition, since the coupling protrusions 330a and the coupling grooves 330b are formed at both sides of the earphone cable 330 over an entire or partial length thereof, the earphone cable 330 may be wound into a spiral shape by female-male coupling between the coupling protrusions 330a and the coupling grooves 330b when the earphone cable 330 is wound in a longitudinal direction, thereby being integrally coupled. The coupling protrusions 330a and the coupling grooves 330b may vertically be formed in parallel with the longitudinal direction of the earphone cable 330. For example, as illustrated in FIGS. 9a, 9b, and FIG. 9c, the coupling protrusions 330a are longitudinally, lengthily formed at one side of the earphone cable 330 in parallel with the longitudinal direction of the earphone cable 330, and the coupling grooves 330b are longitudinally, lengthily formed at another side of the earphone cables 330 in parallel with the longitudinal direction of the earphone cable 330. Accordingly, the earphone cable 330 has a double-sided uneven cross-sectional shape, i.e., a double-sided structure, wherein female and male parts are distinguished. In addition, when the earphone cable 330 is wound into a spiral shape in a longitudinal direction, the vertical coupling protrusions 330a formed at one side of the earphone cables 330 are inserted into and coupled with the vertical coupling grooves 330b formed at another side of the earphone cable 330. Alternatively, as illustrated in FIGS. 10a, 10b, and 10c, coupling protrusions 330a and coupling grooves 330c are longitudinally, lengthily formed at one side of earphone cable 330 in parallel with the longitudinal direction of an earphone cable 330, and coupling grooves 330b and coupling protrusions 330d are longitudinally, lengthily formed at another side of the earphone cable 330 in parallel with the longitudinal direction of the earphone cable 330. Accordingly, the earphone cable 330 has a double-sided dual uneven cross-sectional shape, i.e., a symmetrical double-sided structure, wherein female and male parts are not distinguished. When the earphone cable 330 is wound into a spiral shape in a longitudinal direction, the vertical coupling protrusions 330a formed at one side of the earphone cable 330 may be inserted into and coupled with the vertical coupling grooves 330b formed at another side of the earphone cable 330, and the vertical coupling protrusions 330d formed at one side of the earphone cable 330 may be inserted into and coupled with the vertical coupling grooves 330c formed at another side of the earphone cable 330. Here, as illustrated in enlarged parts of FIG. 10a, outward projections 3 are formed at both sides of the coupling protrusions 330a and 330d, and inward projections 4 are formed at both sides of the coupling grooves 330b and 330c. Accordingly, when the coupling protrusions 330a and 330d are inserted into the coupling grooves 330b and 330c, the outward projections 3 of the coupling protrusions 330a and 330d are fastened to the inward projections 4 of the coupling grooves 330b and 330c, whereby coupling strength between the coupling protrusions 330a and 330d and the coupling grooves 330b and 330c may be strengthened. In addition, coupling strength between the coupling protrusions 330a and 330d and the coupling grooves 330b and 330c and the ease of separation from each other thereof may be properly controlled depending upon the depths and sizes of the projections 3 and 4. By separably coupling the double-sided vertical coupling protrusions 330a and coupling grooves 330b of the earphone cable 330 with each other like this, the bifurcately branched first and second earphone cables 331 and 332 are integrated into one earphone cable, thereby preventing the earphone cable 230 from becoming twisted or entangled upon storage or carrying of an earphone. In addition, when the earphone cable 330 is wound in a longitudinal direction, the earphone cable 330 are wound into a spiral shape by female-male coupling between the vertical coupling protrusions 330a and 330d and the coupling grooves 330b and 330c formed at both sides of the earphone cable 330 and thus integrally coupled, thereby providing convenient storage. At the earphone cable 330, a stopper 335 for preventing the detachable/attachable operation part 340 from downwardly moving may be installed. The stopper 335 is preferably installed a part at which the first and second earphone cables 331 and 332 are branched. In addition, at any one of the branch first and second earphone cables 331 and 332 of the earphone cable 330, a microphone and a volume control button (not shown) may be provided.

Hereinafter, an operation principle of the earphone device 300 according to the third preferred example of the present invention is described. By engaging the coupling protrusions 330a and the coupling grooves 330b, which are longitudinally, lengthily formed in parallel with the longitudinal direction of the earphone cable 330 at mutually facing surfaces of the first and second earphone cables 331 and 332, with each other by female-male coupling, the bifurcately branched first and second earphone cables 331 and 332 may be integrated into one earphone cable. Accordingly, the earphone cable 330 may be prevented from becoming twisted or entangled upon storage and carrying of an earphone. In addition, upon use of the earphones, the first earphone cable 331 and the second earphone cable 332 are separated from each other by releasing coupling between the coupling protrusions 330a and the coupling grooves 330b, and thus, the earphones may be used. In addition, since the coupling protrusions 330a and the coupling grooves 330b are longitudinally, lengthily formed at both sides of each of the first and second earphone cables 331 and 332 in parallel with the longitudinal direction of the earphone cable 330, the vertical coupling protrusions 330a formed at one side of the earphone cable 330 are inserted into and female-male coupled with the vertical coupling grooves 330b formed at another side of the earphone cable 330, when the earphone cable 330 is wound in a longitudinal direction. Accordingly, the earphone cable 330 is wound into a spiral shape and thus integrally coupled. Accordingly, branched parts from the earphone cable 330 are integratively coupled, thereby preventing the earphone cable 330 from being entangled or twisted upon storage or carrying of the earphone, and allowing one cable 330 to be integratively coupled, without using a separate coupling member, by female-male coupling between the vertical coupling protrusions 330a and coupling grooves 330b formed at both sides of the earphone cable 330 when the earphone cable 330 is wound. Therefore, the volume of the earphones device 300 is reduced and storage thereof is facilitated.

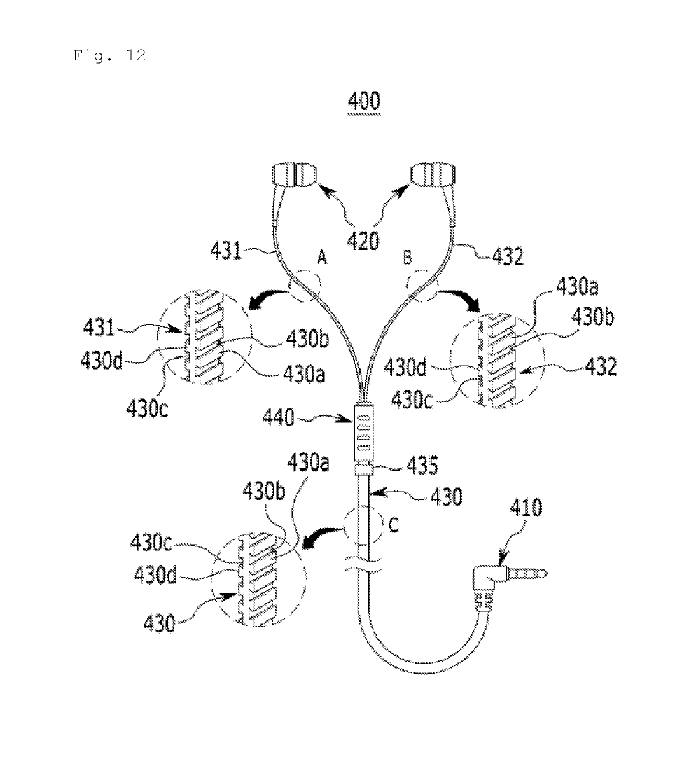

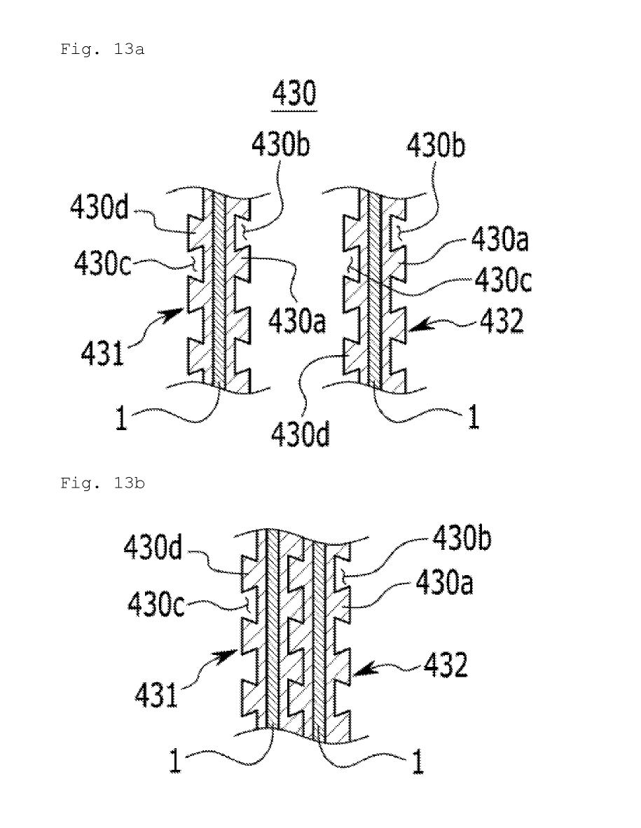

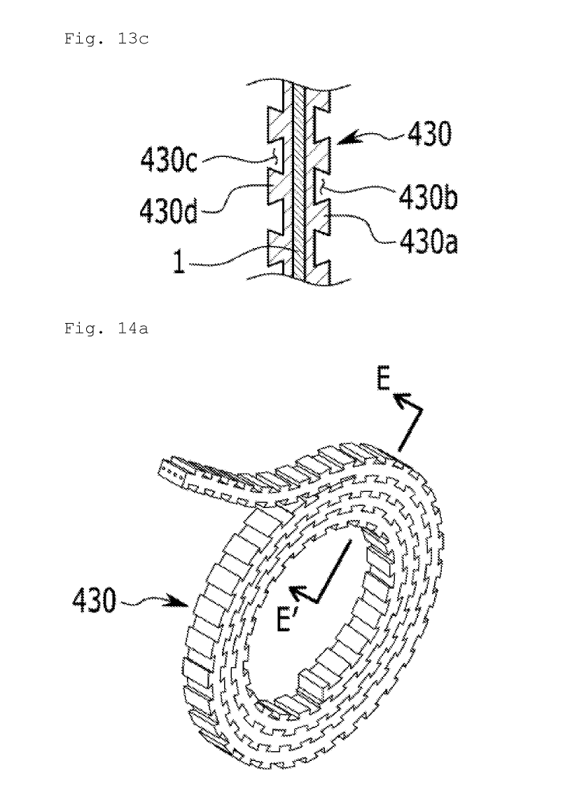

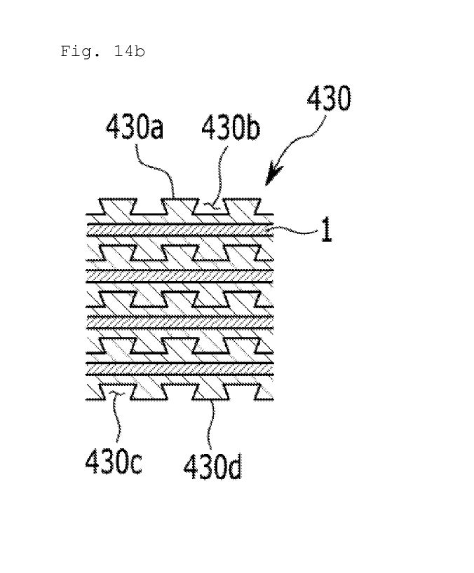

FIG. 12 illustrates a front view of an earphone device according to a fourth preferred example of the present invention. FIG. 13a illustrates a sectional view of an embodiment of A, B, and C parts of FIG. 12. Particularly, a longitudinal sectional view of separated A and B parts is illustrated. FIG. 13b illustrates a sectional view of an embodiment of A, B, and C parts of FIG. 12. Particularly, a longitudinal sectional view of coupled A and B parts is illustrated. FIG. 13c illustrates a sectional view of an embodiment of A, B, and C parts of FIG. 12. Particularly, a longitudinal sectional view of a C part is illustrated. FIG. 14a illustrates a state of earphone cables wound into a spiral shape and integratively coupled with each other, upon storage of an earphone device according to a fourth preferred example of the present invention. FIG. 14b illustrates a sectional view taken along E-E′ line of FIG. 14a.

As illustrated in FIGS. 12 to 14, the earphone device 400 according to the fourth preferred example of the present invention may include an earphone jack 410, earphone speakers 420, an earphone cable 430, and a detachable/attachable operation part 440. Descriptions of these components, except for the earphone cable 430, are the same as the particulars of the first example described referring to FIGS. 1 to 4. Accordingly, detailed descriptions of components performing the same functions as those of the first example, the earphone jack 410, the earphone speakers 420, and the detachable/attachable operation part 440 are omitted.

An end of the earphone cable 430 is connected to the earphone jack 410, and an electrical signal of an acoustic device is transmitted to the earphone speakers 420 connected to another end of the earphone cable 430. An electric wire for transmitting a sound signal is accommodated in the interior of the earphone cable 430. The earphone cable 430 is preferably made of a flexible material and is preferably formed in a thin and long plate shape. The earphone cable 430 extends a predetermined length from the earphone jack 410 and is branched into the first and second earphone cables 431 and 432 at a predetermined part in a “Y” shape. Accordingly, the first and second earphone cables 431 and 432 are respectively connected to a pair of the earphone speakers 420. At mutually facing surfaces of an entire or partial length of the first and second earphone cables 431 and 432, coupling protrusions 430a and 430d and coupling grooves 430b and 430c are formed, whereby the first earphone cable 431 are separably coupled with the second earphone cable 432 by female-male coupling between the coupling protrusions 430a and 432b and the coupling grooves 430b and 430c. In addition, since the coupling protrusions 430a and 430d and the coupling grooves 430b and 430c are formed at both sides of the earphone cable 430 over an entire or partial length thereof, the earphone cable 430 may be wound into a spiral shape by female-male coupling between the coupling protrusions 430a and 430d and the coupling grooves 430b and 430c when the earphone cable 430 is wound in a longitudinal direction, thereby being integrally coupled. The coupling protrusions 430a and 430d and the coupling grooves 430b and 430c may vertically be formed in parallel with the longitudinal direction of the earphone cable 430. The coupling protrusions 430a and 430d and the coupling grooves 430b and 430c may be alternately, repeatedly formed in the longitudinal direction of the earphone cable 430. For example, as illustrated in FIGS. 13a, 13b, and 13c, the earphone cable 430 has a double-sided uneven cross-sectional shape wherein the coupling protrusions 430a and 430d and coupling grooves 430b and 430c having a horizontal shape perpendicular to the longitudinal direction of the earphone cable 430 are alternately, repeatedly formed in the longitudinal direction of the earphone cable 430 at both sides of the earphone cable 430. In addition, when the earphone cable 430 is wound into a spiral shape in a longitudinal direction thereof, the coupling protrusions 430a and coupling grooves 430b formed at one side of the earphone cable 430 are respectively, correspondingly into the coupling grooves 430c and coupling protrusions 430d formed at another side of the earphone cable 430. By separably coupling the double-sided horizontal coupling protrusions 430a and 430d and coupling grooves 430b and 430c of the earphone cable 430 with each other like this, the bifurcately branched first and second earphone cables 431 and 432 are integrated into one earphone cable, thereby preventing the earphone cable 230 from becoming twisted or entangled upon storage or carrying of an earphone. In addition, when the earphone cable 430 is wound in a longitudinal direction, the earphone cable 430 are wound into a spiral shape by female-male coupling between the horizontal coupling protrusions 430a and 430d and the coupling grooves 430b and 430c formed at both sides of each of the first and second earphone cables 431 and 432 and thus integrally coupled, thereby providing convenient storage. At the earphone cable 430, a stopper 435 for preventing the detachable/attachable operation part 440 from downwardly moving may be installed. The stopper 435 is preferably installed a part at which the first and second earphone cables 431 and 432 are branched. In addition, at any one of the branch first and second earphone cables 431 and 432 of the earphone cable 430, a microphone and a volume control button (not shown) may be provided.

Hereinafter, an operation principle of the earphone device 400 according to the fourth preferred example of the present invention is described. By engaging the coupling protrusions 430a and 430d and the coupling grooves 430b and 430c, which have a horizontal shape perpendicular to the longitudinal direction of the earphone cable 430 at mutually facing surfaces of the first and second earphone cables 431 and 432 and alternately, repeatedly formed in a longitudinal direction of the earphone cable 430, with each other by female-male coupling, the bifurcately branched first and second earphone cables 431 and 432 may be integrated into one earphone cable. Accordingly, the earphone cable 430 may be prevented from becoming twisted or entangled upon storage and carrying of an earphone. In addition, upon use of the earphones, the first earphone cable 431 and the second earphone cable 432 are separated from each other by releasing coupling between the coupling protrusions 430a and 430d and the coupling grooves 430b and 430c, and thus, the earphones may be used. In addition, since the coupling protrusions 430a and 430d and the coupling grooves 430b and 430c having a horizontal shape perpendicular to the longitudinal direction of the earphone cable 430 are alternately, repeatedly formed at both sides of each of the first and second earphone cables 431 and 432, the horizontal coupling protrusions 430a and coupling grooves 430b formed at one side of the first and second earphone cable 430 are respectively, correspondingly inserted into and female-male coupled with the horizontal coupling grooves 430c and coupling protrusions 430d formed at another side of each of the earphone cable 430, when the earphone cable 430 is wound in a longitudinal direction. Accordingly, the earphone cable 430 is wound into a spiral shape and thus integrally coupled. Accordingly, branched parts from the earphone cable 430 are integratively coupled, thereby preventing the earphone cable 430 from being entangled or twisted upon storage or carrying of the earphone, and allowing one cable 430 to be integratively coupled, without using a separate coupling member, by female-male coupling between the vertical coupling protrusions 430a and 430d and coupling grooves 430b and 430c formed at both sides of each of the first and second earphone cables 431 and 432 when the earphone cable 430 is wound. Therefore, the volume of the earphones device 400 is reduced and storage thereof is facilitated.

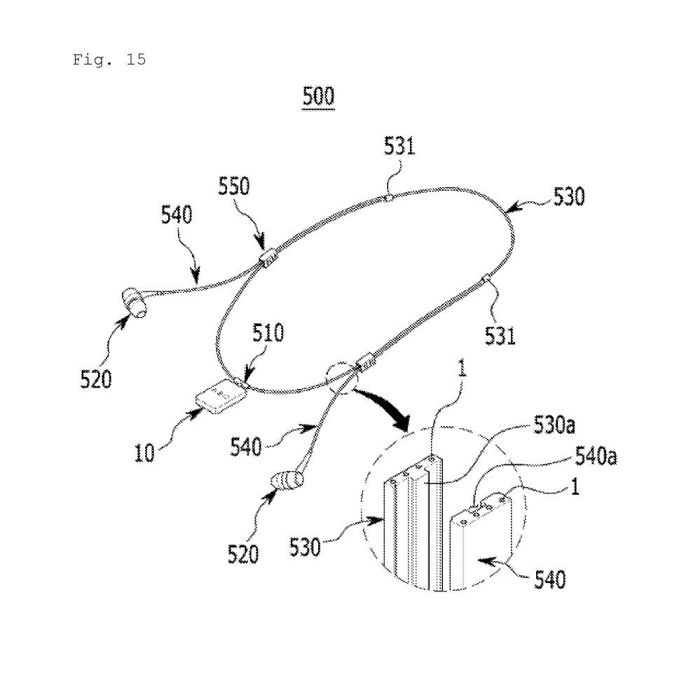

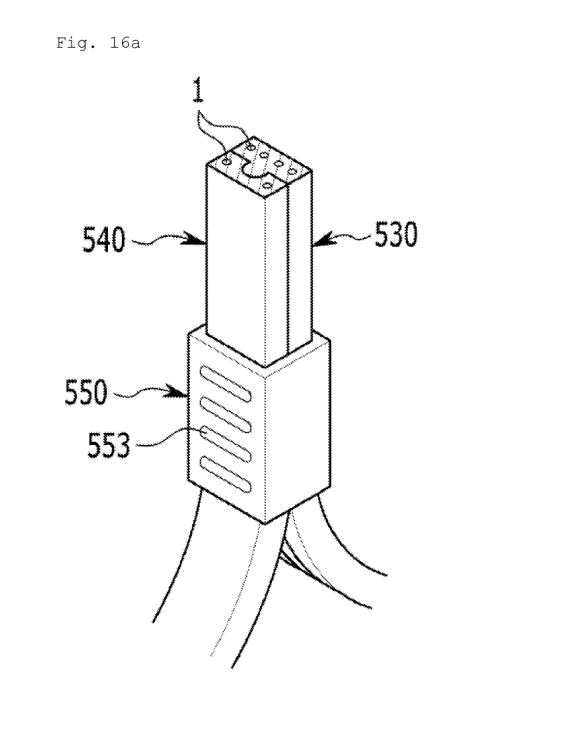

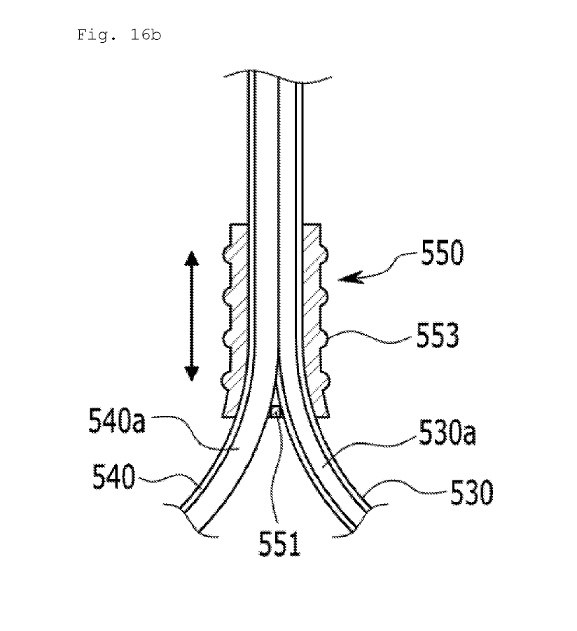

FIG. 15 illustrates a perspective view of an earphone device according to a fifth preferred example of the present invention. FIG. 16a is a perspective view showing an operation state of a detachable/attachable operation part illustrated in FIG. 15. FIG. 16b illustrates a longitudinal sectional view of the detachable/attachable operation part of FIG. 16a

As illustrated in FIGS. 15 and 16, the earphone device 500 according to the fifth preferred example of the present invention is a necklace-type earphone and may include an earphone jack 510, earphone speakers 520, a necklace-type cable 530, an earphone cable 540, and a detachable/attachable operation part 550. Descriptions of these components, except for the necklace-type cable 530, the earphone cable 540, and the detachable/attachable operation part 550, are the same as the particulars of the first example described referring to FIGS. 1 to 4. Accordingly, detailed descriptions of components performing the same functions as those of the first example, the earphone jack 510, and the earphone speakers 520 are omitted.

The necklace-type cable 530 extends a predetermined length from the earphone jack 510, and is formed in a circular necklace shape to be hanged around user's neck. An electric wire 1 for transmitting a sound signal, which is transmitted from the earphone jack 510 connected to an acoustic device 10, to the earphone cable 540 is accommodated in the necklace-type cable 530. The necklace-type cable 530 is preferably made of a flexible material and manufactured in a thin and long plate shape.

The earphone cable 540 is branched from the necklace-type cable 530 and connected to the earphone speakers 520. The electric wire 1 for transmitting a sound signal, which is transmitted via the electric wire 1 of the necklace-type cable 530, to the earphone speakers 520 is accommodated in the earphone cable 540. The earphone cable 540 is preferably made of a flexible material and manufactured in a thin and long plate shape.

Coupling protrusion 530a and coupling groove 540a are formed at mutually facing surfaces of the necklace-type cable 530 and the earphone cable 540, whereby the necklace-type cable 530 and the earphone cable 540 may be separably coupled to each other by female-male coupling between the coupling protrusion 530a and the coupling groove 540a. The coupling protrusion 530a and the coupling groove 540a are vertically formed in parallel with the longitudinal direction of the necklace-type cable 530 and earphone cable 540. For example, as illustrated in FIG. 15, the coupling protrusion 530a may be longitudinally, lengthily formed at one side of the necklace-type cable 530 in parallel with the longitudinal direction of the necklace-type cable 530, and the coupling groove 540a may have an uneven cross-sectional shape characterized by being longitudinally, lengthily formed in parallel with the longitudinal direction of the earphone cable 540 such that the coupling protrusion 530a are inserted into the coupling groove 540a, at one side of the earphone cable 540 facing the side of the necklace-type cable 530. Alternatively, although not shown in the drawing, a coupling groove may be formed at one side of the necklace-type cable 530, and one side of the earphone cable 540 facing the side of the necklace-type cable 530 may have an uneven cross-sectional shape characterized by a coupling protrusion into which the coupling groove is inserted.

The detachable/attachable operation part 550 is installed to move between the necklace-type cable 530 and the earphone cable 540 and along the same. Due to movement of the detachable/attachable operation part 550 along the necklace-type cable 530 and the earphone cable 540, the coupling protrusion 530a and the coupling groove 540a may be separated from each other or coupled with each other.

Hereinafter, an operation principle of the earphone device 500 according to the fifth preferred example of the present invention is described. By engaging the coupling protrusions 530a with the coupling grooves 540a, which are longitudinally, lengthily formed at mutually facing surfaces of the necklace-type cable 530 and the earphone cable 540 in parallel with the longitudinal direction of the necklace-type cable 530 and earphone cable 540, by female-male coupling, branched earphone cables 540 may be integrated into the necklace-type cable 530. Accordingly, the earphone cable 540 may be prevented from becoming twisted or entangled upon storage and carrying of an earphone. In addition, upon use of the earphones, the earphone cable 540 may be separated from the necklace-type cable 530 by releasing coupling between the coupling protrusion 530a and the coupling groove 540a, and thus, the earphones may be used. In addition, the coupling protrusion 530a and the coupling groove 540a are coupled with each other or separated from each other by movement of the detachable/attachable operation part 550. Particularly, the detachable/attachable operation part 550 is moved toward the earphone speakers 520 to couple the coupling protrusion 530a with the coupling groove 540a, and the detachable/attachable operation part 550 is moved toward the stopper 531 to separate the coupling protrusion 530a separated from the coupling groove 540a. Accordingly, the separation may be accomplished by small force due to the presence of an operation projection 551. Therefore, by designing the branched parts of the earphone cable 540 to be integratively coupled to the necklace-type cable 530, the earphone cable 540 is prevented from being entangled or twisted and being disconnected upon storage or carrying of the earphone. In addition, convenience of use may be increased by designing a branched length of the earphone cable 540 to be controlled.

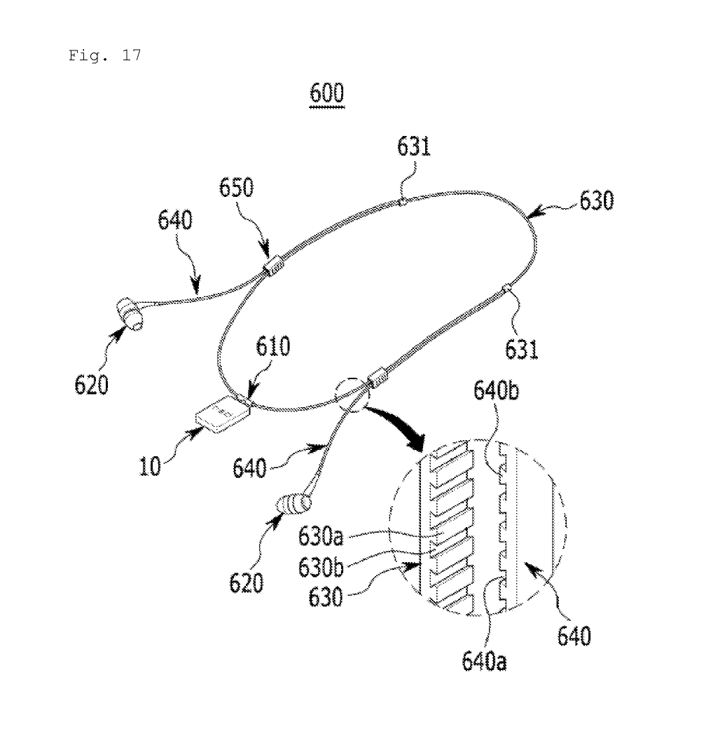

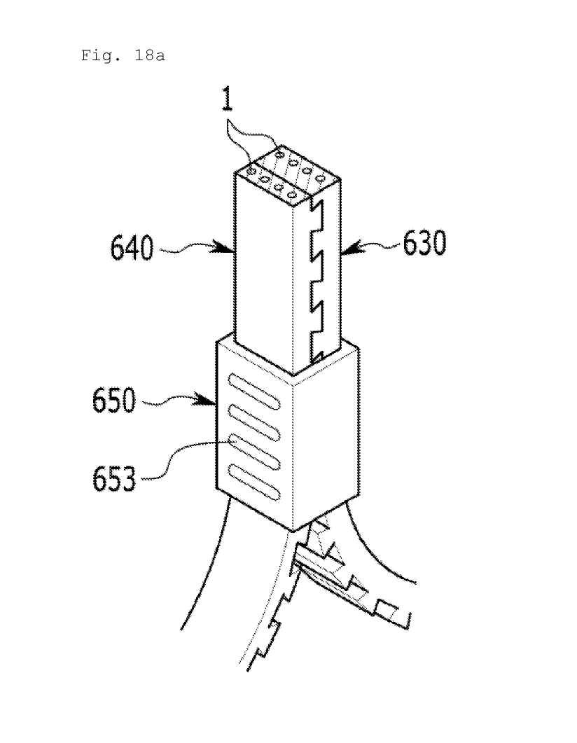

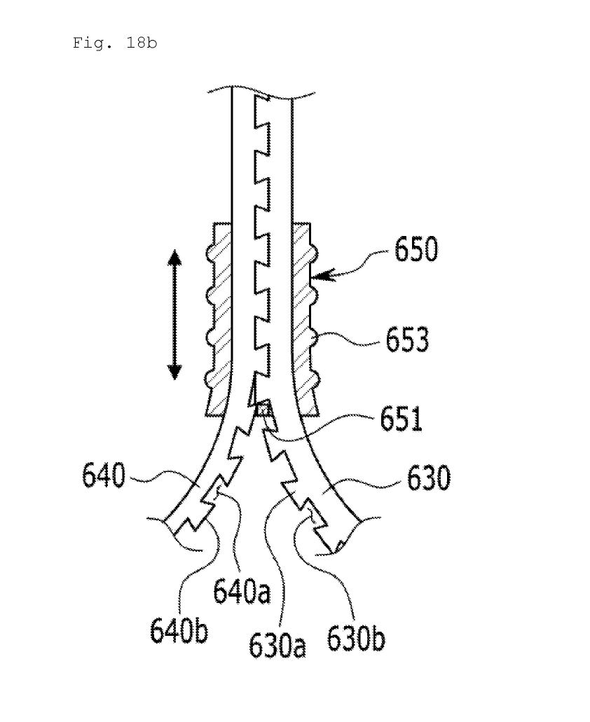

FIG. 17 illustrates a perspective view of an earphone device according to a sixth preferred example of the present invention. FIG. 18a is a perspective view showing an operation state of a detachable/attachable operation part illustrated in FIG. 17. FIG. 18b illustrates a longitudinal sectional view of the detachable/attachable operation part of FIG. 18a.

As illustrated in FIGS. 17 and 18, the earphone device 600 according to the sixth preferred example of the present invention may include an earphone jack 610, earphone speakers 620, a necklace-type cable 630, an earphone cable 640, and a detachable/attachable operation part 650. Descriptions of these components, except for the necklace-type cable 630, and the earphone cable 640, are the same as the particulars of the fifth example described referring to FIGS. 15 to 16. Accordingly, detailed descriptions of components performing the same functions as those of the fifth example, the earphone jack 610, the earphone speakers 620, and the detachable/attachable operation part 650 are omitted.

Coupling protrusions 630a and 640b and the coupling grooves 630b and 640a are formed at mutually facing surfaces of the necklace-type cable 630 and the earphone cable 640, whereby the necklace-type cable 630 and the earphone cable 640 may be separably coupled to each other by female-male coupling between the coupling protrusions 630a and 640b and the coupling grooves 630b and 640a. The coupling protrusions 630a and 640b and the coupling grooves 630b and 640a are vertically formed in a horizontal shape perpendicular to the longitudinal direction of the necklace-type cable 630 and earphone cable 640. For example, as illustrated in FIG. 17, each of the necklace-type cable 630 and earphone cable 640 has an one-sided uneven cross-sectional shape wherein the coupling protrusions 630a and the coupling grooves 630b are alternately, repeatedly formed in a horizontal shape perpendicular to the longitudinal direction of the necklace-type cable 630 at one side of the necklace-type cable 630, along the longitudinal direction of the necklace-type cable 630, and, at one side of the earphone cable 640 facing the side of the necklace-type cable 630, the coupling grooves and protrusions 640a and 640b are alternately, repeatedly formed in a horizontal shape perpendicular to the longitudinal direction of the earphone cable 640 along the longitudinal direction of the earphone cable 640 such that the coupling protrusions 630a and the coupling grooves 630b of the necklace-type cable 630 are respectively, correspondingly inserted into the coupling grooves 640a and the coupling protrusions 640b.

Hereinafter, an operation principle of the earphone device 600 according to the sixth preferred example of the present invention is described. By engaging the coupling protrusions 630a and 640b with the coupling grooves 630b and 640a, which are alternately, repeatedly, formed at mutually facing surfaces of the necklace-type cable 630 and the earphone cable 640 in a horizontal shape perpendicular to the longitudinal direction of the necklace-type cable 630 and earphone cable 640 and along the longitudinal direction of the necklace-type cable 630 and earphone cable 640, by female-male coupling, branched earphone cables 640 may be integrated into the necklace-type cable 630. Accordingly, the earphone cable 640 may be prevented from becoming twisted or entangled upon storage and carrying of an earphone. In addition, upon use of the earphones, the earphone cable 640 may be separated from the necklace-type cable 630 by releasing coupling between the coupling protrusion 630a and 640b and the coupling groove 630b and 640a, and thus, the earphones may be used. In addition, the coupling protrusion 630a and 640b and the coupling groove 630b and 640a are coupled with each other or separated from each other by movement of the detachable/attachable operation part 650. Particularly, the detachable/attachable operation part 650 is moved toward the earphone speakers 620 to couple the coupling protrusion 630a and 640b with the coupling groove 630b and 640a, and the detachable/attachable operation part 650 is moved toward the stopper 631 to separate the coupling protrusion 630a and 640b separated from the coupling groove 630b and 640a. Accordingly, the separation may be accomplished by small force. Therefore, by designing the branched parts of the earphone cable 640 to be integratively coupled to the necklace-type cable 630, the earphone cable 640 is prevented from being entangled or twisted and being disconnected upon storage or carrying of the earphone. In addition, convenience of use may be increased by designing a branched length of the earphone cable 640 to be controlled.

Although embodiments of the present invention have been described with reference to the accompanying drawings, those skilled in the art will understand that the present invention can be easily changed or modified into other specified forms without change or modification of the technical spirit or essential characteristics of the present invention. Therefore, it should be understood that the aforementioned examples are only provided by way of example and not provided to limit the present invention. It should be understood that the scope of the present invention is defined by the following claims, rather than the detailed description, and the invention is to cover all modifications, equivalents, and alternatives falling within the spirit and scope of the invention as defined by the claims.

1. An earphone device, comprising an earphone jack connected to an acoustic device; a pair of earphone speakers for outputting sound; and an earphone cable extending a predetermined length from the earphone jack and branched to first and second earphone cables at a predetermined part, wherein the branched first and second earphone cables are respectively connected to a pair of earphone speakers, coupling protrusions and grooves are formed at mutually facing surfaces of the first and second earphone cables, and the first earphone cable is separably coupled with the second earphone cable by female-male coupling between the coupling protrusions and the coupling grooves.

2. The earphone device according to claim 1, wherein the coupling protrusions and the coupling grooves are formed at both sides of the earphone cable, and thus, the earphone cable is wound into a spiral shape by female-male coupling between the coupling protrusions and the coupling grooves when the earphone cable is wound in a longitudinal direction, thereby being integrally coupled.

3. An earphone device, comprising an earphone jack connected to an acoustic device; a pair of earphone speakers for outputting sound; and an earphone cable extending a predetermined length from the earphone jack and branched to first and second earphone cables at a predetermined part, wherein the branched first and second earphone cables are respectively connected to a pair of earphone speakers and coupling protrusions and grooves are formed at both sides of the earphone cable, wherein, when the earphone cable is wound in a longitudinal direction, the earphone cable is wound into a spiral shape by female-male coupling between the coupling protrusions and the coupling grooves and thus integrally coupled.

4. The earphone device according to claim 1, wherein the coupling protrusions and the coupling grooves are vertically in parallel with a longitudinal direction of the earphone cable.

5. The earphone device according to claim 4, wherein the earphone cable has an one-sided uneven cross-sectional shape wherein coupling protrusions are formed at one side of the first earphone cable, and coupling grooves are formed such that the coupling protrusions are inserted into one side of the second earphone cable facing the side of the first earphone cable.

6. The earphone device according to claim 4, wherein the earphone cable has an one-sided uneven cross-sectional shape wherein coupling protrusions and grooves are formed at one side of the first earphone cable, and coupling grooves and protrusions are formed at one side of the second earphone cable facing the side of the first earphone cable such that the coupling protrusions and grooves are respectively, correspondingly inserted into the coupling protrusions and grooves of the first earphone cable.

7. The earphone device according to claim 4, wherein the earphone cable has a double-sided uneven cross-sectional shape wherein coupling protrusions are formed at one side of the earphone cable and coupling grooves are formed at another side of the earphone cable, wherein, when the earphone cable is wound into a spiral shape in a longitudinal direction, the coupling protrusions formed at one side of the earphone cable are inserted into and coupled with the coupling grooves formed at another side of the earphone cable.

8. The earphone device according to claim 4, wherein the earphone cable has a double-sided uneven cross-sectional shape wherein coupling protrusions and grooves are formed at one side of the earphone cable and the coupling grooves and protrusions are formed at another side of the earphone cable, wherein, when the earphone cable is wound into a spiral shape in a longitudinal direction, the coupling protrusions formed at one side of the earphone cable are inserted into and coupled with the coupling grooves formed at another side of the earphone cable and the coupling protrusions formed at the another side of the earphone cable are inserted into and coupled with the coupling grooves formed the side of the earphone cable.

9. The earphone device according to claim 1, wherein the coupling protrusions and the coupling grooves are formed in a horizontal shape perpendicular to a longitudinal direction of the earphone cable.

10. The earphone device according to claim 9, wherein the coupling protrusions and the coupling grooves are alternately, repeatedly formed along a longitudinal direction of the earphone cable.

11. The earphone device according to claim 9, wherein the earphone cable has an one-sided uneven cross-sectional shape wherein coupling protrusions and grooves are alternately, repeatedly formed at one side of the first earphone cable along a longitudinal direction of the first earphone cable, and coupling grooves and coupling protrusions are alternately, repeatedly formed along a longitudinal direction of the second earphone cable at one side of the second earphone cable facing the side at the first earphone cable such that the coupling protrusions of grooves of the first earphone cable are respectively, correspondingly inserted into the coupling protrusions of grooves of the second earphone cable.

12. The earphone device according to claim 9, wherein the earphone cable has a double-sided uneven cross-sectional shape wherein coupling protrusions and grooves are alternately, repeatedly formed at the earphone cable along a longitudinal direction of the earphone cable, wherein, when the earphone cable is wound into a spiral shape in a longitudinal direction, the coupling protrusions and grooves formed at one side of the earphone cable are respectively, correspondingly inserted into and coupled with the coupling grooves and protrusions formed at another side of the earphone cable.

13. The earphone device according to claim 1, further comprising a detachable/attachable operation part that moves between the first and second earphone cables, is installed to move along the earphone cable, and enables the coupling protrusions and the coupling grooves to be separated from each other or coupled with each other by moving along the earphone cable.

14. An earphone device, comprising an earphone jack connected to an acoustic device; earphone speakers for outputting sound; a necklace-type cable extending a predetermined length from the earphone jack and having a circular necklace shape to be hanged around user's neck; and an earphone cable branched from the necklace-type cable and connected to the earphone speakers, wherein coupling protrusions and grooves are formed at mutually facing surfaces of the necklace-type cable and the earphone cable, and thus, the necklace-type cable and the earphone cable are separably coupled with each other by female-male coupling between the coupling protrusions and the coupling grooves.

15. The earphone device according to claim 14, wherein the coupling protrusions and the coupling grooves are vertically in parallel with a longitudinal direction of the necklace-type cable and the earphone cable.

16. The earphone device according to claim 14, wherein the coupling protrusions and the coupling grooves are formed in a horizontal shape perpendicular to a longitudinal direction of the necklace-type cable and the earphone cable.

17. The earphone device according to claim 14, further comprising a detachable/attachable operation part that moves between the necklace-type cable and the earphone cable, is installed to move along the necklace-type cable and the earphone cable, and enables the coupling protrusions and the coupling grooves to be separated from each other or coupled with each other by moving along the necklace-type cable and the earphone cable.
